(19) United States
(12) Patent Application Publication
(10) Pub. No.: US 2006/0204209 A1
(43) Pub. Date: Sep. 14, 2006

(54) Pause strategy for magnetic tape recording

(75) Inventors: Michael A. Blatchley, Longmont, CO (US); Paul Newsome, Buderim (AU); Richard H. McAuliffe, Boulder, CO (US); Randall C. Bauck, Boulder, CO (US)

Correspondence Address: NIXON & VANDERHYE, PC, 901 NORTH GLEBE ROAD, 11TH FLOOR, ARLINGTON, VA, 22203, US

(73) Assignee: Exabyte Corporation, Boulder, CO (US)

(21) Appl. No.: 11/075,818

(22) Filed: Mar. 9, 2005

(51) Int. Cl. H04N 5/91

(52) U.S. Cl. 386/46

(57) ABSTRACT

A helical scan tape recorder (30) comprises a rotatable scanner (84) and a transport system for transporting magnetic tape proximate the rotatable scanner in a manner so that information is recorded during a revolution of the scanner. A controller performs a pause routine (120) for pausing during a recording operation on tape. The pause routine, when executed, performs the steps of: determining a tape pause position reference value indicative of a pre-pause last recording position on the tape; recording an erase signal on the tape after the pre-pause last recording position; rewinding the tape; transporting the tape in a forward direction and obtaining a current tape position value; determining when the current tape position value reaches a predetermined value relative to the tape pause position reference value; and at beginning of a next revolution of the scanner, commencing recording of one or more post-pause stripes on the tape. In an example implementation, the predetermined value relative to the tape pause position reference value is a sum of the tape pause position reference value and an offset.

### BACKGROUND

1. Field of the Invention

The present invention pertains to helical scan recording on magnetic tape, and particularly to executing a pause in a recording operation.

2. Related Art and Other Considerations

In magnetic recording on tape using a magnetic tape drive, relative motion between a head unit (typically with both a write element and a read element) and the tape causes a plurality of tracks of information to be transduced with respect to the tape. The magnetic tape is typically housed in a cartridge which is loaded into the tape drive. The tape extends between a cartridge supply reel and a cartridge take-up reel. The tape drive typically has a supply reel motor for rotating the cartridge supply reel and a take-up reel motor for rotating the cartridge take-up reel.

After the cartridge is loaded into the tape drive, the tape is extracted by mechanisms in the drive so that a segment of the tape is pulled from the cartridge and into a tape path that travels proximate the head unit. The extraction mechanisms take the form of tape guides which are mounted on trolleys. During the extraction operation, trolley motors move the trolleys along a predefined trolley path, so that the tape guides which surmount the trolleys displace the tape into the tape path as the trolleys travel along the trolley path. When the trolleys reach the full extent of travel along the trolley path, the tape is proximate the head unit. Thereafter the tape can be transported past the head unit, e.g., by activation of a capstan.

In a helical scan arrangement, as the magnetic tape is transported the magnetic tape is at least partially wrapped around a rotating drum so that heads (both write heads and read heads) positioned on the drum are contiguous to the drum as the drum is rotated. One or more write heads on the drum physically record data on the tape in a series of discrete stripes or tracks oriented at one or more angles with respect to the direction of tape travel. The data is formatted, prior to recording on the tape, to provide sufficient referencing information to enable later recovery during readout by one or more read heads.

Examples of helical scan apparatus (e.g., helical scan tape drives) are described in the following non-exhaustive and exemplary list of United States Patents and United States patent publications: U.S. Pat. No. 5,065,261; U.S. Pat. No. 5,068,757; U.S. Pat. No. 5,142,422; U.S. Pat. No. 5,191,491; U.S. Pat. No. 5,535,068; U.S. Pat. No. 5,602,694; U.S. Pat. No. 5,680,269; U.S. Pat. No. 5,689,382; U.S. Pat. No. 5,726,826; U.S. Pat. No. 5,731,921; U.S. Pat. No. 5,734,518; U.S. Pat. No. 5,953,177; U.S. Pat. No. 5,973,875; U.S. Pat. No. 5,978,165; U.S. Pat. No. 6,144,518; U.S. Pat. No. 6,189,824; U.S. Pat. No. 6,288,864; U.S. Pat. No. 6,697,209; U.S. Pat. No. 6,367,047; U.S. Pat. No. 6,367,048; U.S. Pat. No. 6,603,618; U.S. Pat. No. 6,381,706; U.S. Pat. No. 6,421,805; U.S. Pat. No. 6,308,298; U.S. Pat. No. 6,307,701; U.S. Pat. No. 6,246,551; U.S. Patent Publication 2002/0071195; U.S. Patent Publication 2003/0048563; U.S. Patent Publication 2003/0128459; U.S. Patent Publication 2003/0234998. The foregoing are all incorporated herein by reference in their entirety, the corresponding US patent applications for the foregoing US Patent publications also being incorporated herein.

Prior art helical scan tape drives can have a plurality of heads mounted on the rotating drum. In some embodiments, plural write heads and plural read heads are provided on the cylindrical sidewall of the drum, often in pairs. For example, a pair of write heads may be situated relatively close together on one side of the drum, while at an approximately 180 degree angle from the write heads a pair of read heads are mounted in close proximity to one another. Typically, a stripe recorded by a first write head on a first half of a drum revolution is read back by a first read head on a second half of the same drum revolution, and similarly a stripe recorded by a second write head on the first half of the same drum revolution is read back by a second read head on the second half of the same drum revolution.

Many tape drives are plural azimuth systems in which various sets of transducing elements traverse paths having different azimuth angles relative to the direction of tape travel. For example, a first write head and a first read head may be configured to traverse stripes having a first azimuth angle; a second write head and a second read head may be configured to traverse stripes having a second azimuth angle; and so forth. Stripes or tracks are typically arranged in alternating azimuth manner, with stripes of differing azimuth angles usually having edge portions which slightly overlay an adjacent stripe of different azimuth angle.

In magnetic tape recording, the term “pause” refers to stopping the forward motion of the tape across the scanner or drum. The purpose of pausing the tape can be for either of two reasons. A first reason is to better match the host data transfer rate. Namely when there is no more data available from the host, the drives pauses. Conversely when more data becomes available, the drive resumes recording. A second reason for pausing the tape is to avoiding having to repositioning tape by performing a back hitch operation. A back hitch is where the drive stops tape motion, reverses and backs up to a point well before the stop point (e.g., a fairly long reverse motion), stops again, and then goes forward to splice at the point of where the drive stopped writing on tape. Avoiding a back hitch operation reduces wear and tear on the mechanism and the tape.

Some prior art helical scan drives are not able to precisely control where the beginning of recording occurs on tape after a pause event. It is important not to overwrite the user data that was written before the pause. To prevent this, some of these drives use additional dummy tracks on either side of the pause point to avoid destroying the data before the pause. These dummy tracks give a physical buffer zone on tape to avoid mixing the pre-pause data from the post-pause data. These dummy tracks are ignored when reading the tape.

Most helical scan recording systems utilize the alternate azimuth recording technology mentioned above. Alternate azimuth recording allows multiple tracks to be recorded with no dead zone or physical separation between the tracks. For alternate azimuth recorded data tracks to be read correctly, no two tracks of the same azimuth should be recorded contiguously or in a manner that they could be traversed at the same time by a same azimuth read head. If such were to happen, a problem situation results in that the two tracks will not be discernable and therefore neither track would be readable at a normal transfer speed.

Unfortunately, a pause event can create just such a problem situation, as illustrated in FIG. 5. When the drive coasts to a stop, and recording is turned off, and then subsequently the drive moves forward and recording is again started, a gap in the recording session can be created. This gap can involve previously recorded tracks. If the pre-pause track in the gap closest to the new recording track was recorded with the same azimuth head as the newly recorded track, the newly recorded track will be unreadable. On some tape drives this problem is overcome by the writing of dummy tracks, as mentioned above. Since these dummy tracks do not contain user data, not being able to read them is not a problem.

However, the drawback to the dummy track approach is wasted capacity. Wasted capacity is a cardinal sin for a storage device. In fact, in some tape drives typically four to six tracks are consumed by each pause event. Depending on the native density of the device and the number of pause events, this loss of capacity can amount to a sizable percentage of a single tape cartridge capacity.

What is needed, therefore, and an object of the present invention, is a technique of pausing during recording on magnetic tape that looses very little tape capacity.

### BRIEF SUMMARY

A helical scan tape recorder comprises a rotatable scanner and a transport system for transporting magnetic tape proximate the rotatable scanner in a manner so that information is recorded during a revolution of the scanner. A controller performing a pause routine for pausing during a recording operation on tape. The pause routine, when executed, performs the steps of: determining a tape pause position reference value indicative of a pre-pause last recording position on the tape; recording an erase signal on the tape after the pre-pause last recording position; rewinding the tape; transporting the tape in a forward direction and obtaining a current tape position value; determining when the current tape position value reaches a predetermined value relative to the tape pause position reference value; and at beginning of a next revolution of the scanner, commencing recording of one or more post-pause stripes on the tape. In an example implementation, the predetermined value relative to the tape pause position reference value is a sum of the tape pause position reference value and an offset.

### BRIEF DESCRIPTION OF THE DRAWINGS

The foregoing and other objects, features, and advantages of the invention will be apparent from the following more particular description of preferred embodiments as illustrated in the accompanying drawings in which reference characters refer to the same parts throughout the various views. The drawings are not necessarily to scale, emphasis instead being placed upon illustrating the principles of the invention.

FIG. 1 is a schematic view of an example embodiment of a tape drive.

FIG. 2 is a diagrammatic view of an example tape path for a tape drive such as the example tape drive of FIG. 1.

FIG. 3 is a flowchart showing basic, example, non-limiting steps involved in a pause routine performed in accordance with an example mode of the technology.

FIG. 4 is a diagrammatic view illustrating tape format and content when implementing the pause routine of FIG. 3.

FIG. 5 is a diagrammatic view illustrating a problematic situation of tape format and content without the pause routine of FIG. 3.

### DETAILED DESCRIPTION

In the following description, for purposes of explanation and not limitation, specific details are set forth such as particular architectures, interfaces, techniques, etc. in order to provide a thorough understanding of the present invention. However, it will be apparent to those skilled in the art that the present invention may be practiced in other embodiments that depart from these specific details. In other instances, detailed descriptions of well-known devices, circuits, and methods are omitted so as not to obscure the description of the present invention with unnecessary detail.

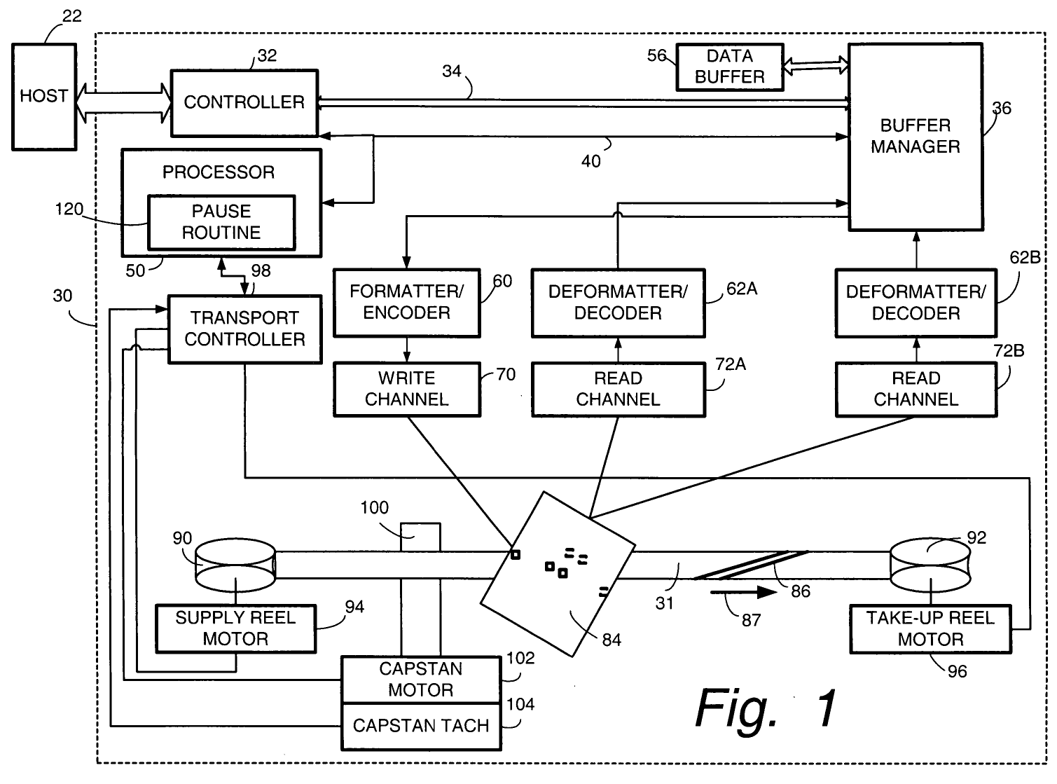

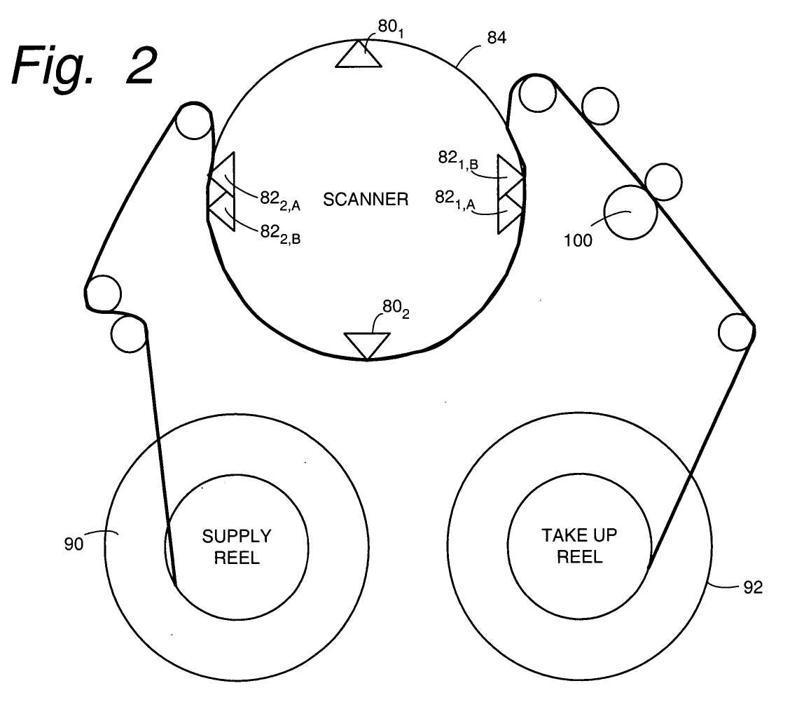

FIG. 1 shows a bus 20 which connects a host computer or user device 22 and a representative, example embodiment of a storage device, particularly tape drive 30. In the illustrated embodiment of both FIG. 1 and FIG. 2, tape drive 30 is shown as a generic helical scan tape drive which transduces information on/from tape 31. Tape drive 30 includes a controller 32 which is connected to bus 20 (see FIG. 1). Data bus 34 connects controller 32 to buffer manager 36. Both controller 32 and buffer manager are connected by a bus system 40 to processor 50. Although not specially illustrated, it is understood that processor 50 can is also connected to program memory and to a data memory, e.g., RAM.

Buffer manager 36 controls, e.g., both storage of user data in buffer memory 56 and retrieval of user data from buffer memory 56. User data is data from host 22 for recording on tape 31 or destined from tape 31 to host 22. Buffer manager 36 is also connected to formatter/encoder 60 and to deformatter/decoders 62A and 62B. Formatter/encoder 60 is, in turn, respectively connected to write channel 70. Deformatter/decoders 62A and 62B are, in turn, respectively connected to read channels 72A and 72B. Write channel 70 is connected via write amplifiers to plural recording element(s) or write head(s) 80; read channels 72A and 72B are connected via read amplifiers to plural read element(s) or read head(s) 82.

Those skilled in the art will appreciate that write channel 70 includes various circuits and elements including a RLL modulator, a parallel-to-serial converter, and write current modulator. Similarly, the person skilled in the art understands that read channels 72A and 72B include a data pattern and clock recovery circuitry, a serial-to-parallel converter, and, an RLL demodulator. These and other aspects of tape drive 30, including (for example) error correction, are not necessary for an understanding of the present technology and accordingly are not specifically described herein. Certain other aspects can be understood from, e.g., U.S. Pat. No. 6,367,047 to McAuliffe et al.; U.S. Pat. No. 6,367,048 to McAuliffe et al.; U.S. Pat. No. 6,603,618 to McAuliffe et al.; and U.S. Pat. No. 6,381,706 to Zaczek; U.S. Pat. No. 6,421,805 to McAuliffe et al.; U.S. Pat. No. 6,308,298 to Blatchley et al.; U.S. Pat. No. 6,307,701 to Beavers et al.; and, U.S. Pat. No. 6,246,551 to Blatchley et al; and simultaneously-filed U.S. patent application Ser. No. ______ (attorney docket: 1300-474), entitled “DATA RANDOMIZATION FOR REWRITING IN RECORDING/REPRODUCTION APPARATUS”, all of which are incorporated by reference herein in their entirety.

Tape drives with any number and placement of write heads 80 and read heads 82 are susceptible to the tape pause technology herein disclosed. It so happens that the particular drive 30 which serves as an example context for illustration has (as shown generally in FIG. 2) two write heads 80₁-80₂ and four read heads 82_{1,A}, 82_{1,B}, 82_{2,A}, 82_{2,B}, situated on a peripheral surface of rotating scanner or drum 84. Write heads 80₁-80₂ are positioned one hundred eighty degrees apart on rotating scanner 84, are of first and second azimuth angles, respectively, and share the same write channel 70. The read heads 82 are group in pairs, e.g., a first pair 82_{1,A}, 82_{1,B}, and a second pair 82_{2,A}, 82_{2,B}. Each read head pair is positioned ninety degrees away from the write heads 80. The first read head of each pair, i.e., read head 82_{1,A} and read head 82_{2,A}, use read channel 72A, while a second read head of each pair, i.e., read head 82_{1,B} and read head 82_{2,B}, use read channel 72B. The first pair of read heads 82_{1,A}, 82_{1,B} are of a same first azimuth angle, with the read head 82_{1,B} reading approximately one track behind read head 82_{1,A}. The second pair of read heads 82_{2,A}, 82_{2,B} are of a same second azimuth angle, with the read head 82_{2,B} reading approximately one track behind read head 82_{2,A}. In the illustrated example implementation, all read heads are normally used in reproducing or reading data from a tape in an overscan mode. However, during a recording operation only one read head of each pair is utilized for a check after write operation.

Tape 31 is wrapped around scanner 84 such that the heads 80 and 82 follow helical stripes 86 (see FIG. 1) on tape 31 as tape 31 is transported in a direction indicated by arrow 87 in FIG. 1 from a supply reel 90 to a take-up reel 92. Supply reel 90 and take-up reel 92 are typically housed in an unillustrated cartridge or cassette from which tape 31 is extracted into a tape path that includes wrapping around scanner 84. The particular tape path is not critical, FIG. 2 providing merely an example tape path configuration. Supply reel 90 and take-up reel 92 are driven by respective reel motors 94 and 96 to transport tape 31 in the direction 87. Reel motors 94 and 96 are driven by transport controller 98, which ultimately is governed by processor 50. A capstan 100 controls tape speed. Capstan 100 is rotated by capstan motor 102. The rotational speed of capstan motor 102, and thus the rotational speed of capstan 100 and linear speed of tape 31, is detected by capstan tachometer 104. Reel motors 94 and 96 and capstan motor 102, and thus capstan 100 itself, are all separately driven by transport controller 98, which ultimately is governed by processor 50. During forward motion of tape 31, the take-up reel motor 96 keeps adequate tension on tape 31 from capstan 100 to the take-up reel 92. The supply reel motor 94 provides backward tension on tape 31 to maintain sufficient pressure against the heads and scanner 84 to write and read tape 31.

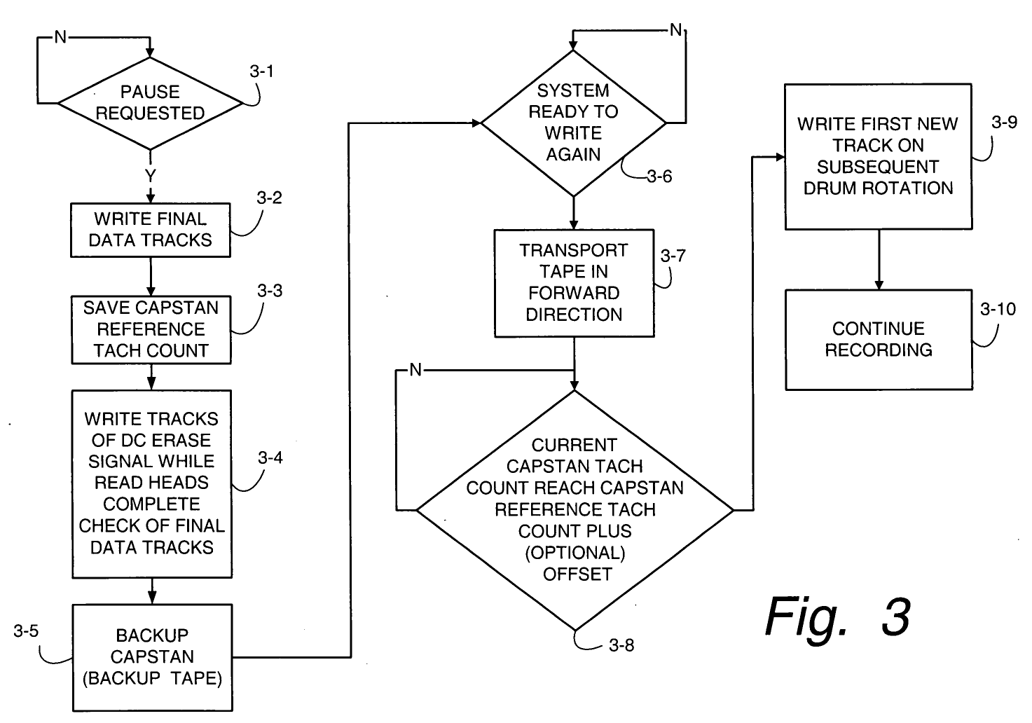

A controller such as processor 50 of the example illustrated tape drive advantageously performs a recording pause routine 120. In many instances the pause routine 120 results in an essentially seamless pause operation. Certain example, basic, non-limiting steps performed by pause routine 120 or events associated therewith are depicted in FIG. 3. What particular unit or architecture is employed for execution of the pause routine 120 is not essential or critical. It will be understood that the pause routine 120 can be performed by any suitable entity capable of executing the basic steps or operations performed herein. Such entity, generically referred to at times herein as a controller, can be or comprise, for example, individual hardware circuits, a suitably programmed digital microprocessor or general purpose computer which executes software or firmware, an application specific integrated circuit (ASIC), and/or using one or more digital signal processors (DSPs). Moreover, the functionality of the pause routine 120 can either be localized at one entity or distributed to several entities.

Step 3-1 of FIG. 3 shows the pause routine 120 awaiting invocation. The step 3-1 can be carried out by having pause routine 120 periodically check or be notified whether a pause operation has been requested. A pause operation can be requested under conditions such as those previously mentioned, e.g., no more data available from the host, so the drives pauses.

As step 3-2, after a pause is requested, the final pre-pause data tracks are written to tape 31. These final pre-pause data tracks are data tracks that bear packets from the remaining contents of data buffer 56. In other words, the drive preferably writes and thereby empties the contents of its data buffer 56 before actually pausing the tape transport.

As step 3-3, pause routine 120 determines a tape pause position reference value indicative of a pre-pause last recording position on the tape. Step 3-2 can be carried out, for example, by consulting the tachometer count obtained from capstan tachometer 104 at the time of the recording of the last pre-pause track. This tape pause position reference value is then stored for a future check, and is indicative of where the drive may begin resuming recording on tape 31 after the pause.

As step 3-4, the pause routine 120 causes recording of a DC erase signal on tape 31 after (e.g., downstream of) the pre-pause last recording position. Preferably the recording of the DC erase signal involves recording tracks of the DC erase signal while the read heads 82 are performing their check after write processing of the last pre-pause tracks just recorded to tape 31. The DC erase signal is a condition in which a constant DC current is applied to the write heads 80 so that the head is magnetized as one pole. This creates the same condition as if one were to pull a magnet across the surface of the magnetic tape and thereby make all magnetic domains orient themselves in one direction. This effectively erases the previously recorded information under the track that was written with the DC erase signal. A typical data recording signal signal looks like an AC waveform.

In the example embodiment tape drive 30 having two write heads 80, and 802, four tracks of the DC erase signal are recorded while the read heads complete their check of the final two data tracks. Of course, in other embodiments having a different number of heads, more or less tracks of the DC erase signal may be recorded.

As step 3-5, the tape 31 is moved backwards (e.g., rewound) a short distance to a tape position earlier than the last recorded pre-pause data track. In the illustrated implementation, such brief backward motion of tape 31 is achieved under control of transport controller 98 in response to the logic of pause routine 120. Specifically, transport controller 98 operates capstan motor 102 and thus capstan 100 so that the tape direction is reversed and the tape is moved back a short distance to a point just earlier than the last recorded pre-pause track. For example, the brief movement is comparable to application of a “kill” pulse to run the capstan 100 backwards a short distance. Such short backward movement, termed a “back twitch”, is much shorter than a back hitch.

Step 3-6 reflects pause routine 120 waiting for the tape drive to be ready to record further data to tape 31. For example, when data buffer 56 has been refilled to a predetermined level, buffer manager 36 send a notification, e.g., to pause routine 120, that recording of data on tape 31 can be resumed.

When the system is indeed ready to resume recording, as step 3-7 pause routine 120 directs transport controller 98 to begin transport of tape 31 in a forward direction. Transport controller 98 achieves the tape transport by sending appropriate signals to capstan motor 102 for rotating capstan 100. As the tape is transported in the forward direction at step 3-7, the pause routine 120 monitors, either continuously or periodically, a current tape position value obtained from capstan tachometer 104.

In operation, the rewind of step 3-5 should be suitably upstream from the position of the last recorded pre-pause track so that before the time the write head reaches the position of the last recorded pre-pause track, the capstan 100 is up to speed.

As step 3-8, the pause routine 120 determines when the current tape position value (being monitored via capstan tachometer 104) reaches a predetermined value relative to the tape pause position reference value. The tape pause position reference value was noted and stored at step 3-3. When it is determined that the current tape position value reaches such predetermined value, the pause routine 120 knows that the recording of a first post-pause track can begin on the next rotation of scanner 84. In other words, after the predetermined value is reached, at beginning of a next revolution of the scanner, the recording of one or more post-pause stripes on the tape can begin. Recording of the first post-pause track is reflected by step 3-9 in FIG. 3.

Thus, step 3-8 involved determining when the current tape position value reached a “predetermined value” relative to the tape pause position reference value. In one mode of operation, the predetermined value can be equal to the tape pause position reference value (stored, e.g., at step 3-3). Yet in another example mode of operation, the predetermined value relative to the tape pause position reference value is a sum of the tape pause position reference value (obtained and stored at step 3-3) and an offset value. As one aspect of the technology, this offset value can be programmable, e.g., selectively changeable or adjustable. The reason for an offset value for this mode is described subsequently.

Step 3-10 of FIG. 3 reflects the fact that the pause routine 120 can exit and that drive 30 can continue recording post-pause tracks in usual fashion.

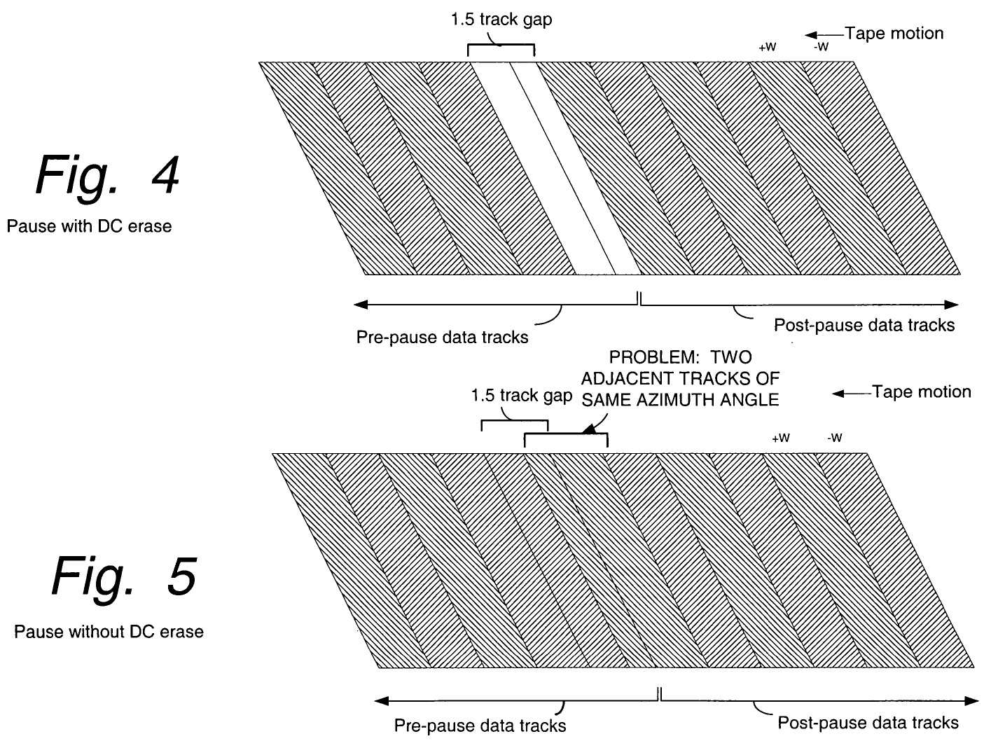

FIG. 4 shows an example content of a tape which has been involved in a pause operation performed by pause routine 120. In FIG. 4, the tape is viewed from the perspective of a write head looking at the recording surface. Unlike the tape of FIG. 5, the tape of FIG. 4 does not have the problematic situation of adjacent tracks (one pre-pause, another post-pause) of a same azimuth angle. Rather, in the particular example shown in FIG. 4, the pre-pause tracks are separated by the post-pause tracks by a 1.5 track erase signal gap. FIG. 4 represents just one possible case, other cases being dependent upon the point in the drum rotation at which it is detected that it is permissible to write the first post-pause track. There are essentially two extreme cases, with almost a continuum of other cases therebetween.

In a first extreme case (minimum gap), at step 3-3 the tape is backed up so that, when traversing of tracks begins upon start up of tape transport (step 3-7), a first azimuth angle head (e.g., +azimuth angle) will traverse a path which substantially overlies an already-recorded +azimuth angle track. In this first case, the first post-pause track which will be recorded will be written essentially exactly after the last pre-pause track, so that there is a pause with essentially no gap on the tape.

In a second extreme case (maximum gap case), the head just missed starting to traverse the track when the requirement of step 3-8 was satisfied, and therefore the pause routine 120 has to wait an entire revolution before writing the first post-pause track. One revolution of the drum means writing two tracks. In this case pause routine 120 will have almost two full tracks of gap. Thus, the resulting gap is essentially a function the point in the drum rotation at which it is detected that it is permissible to write the first post-pause track.

The capstan tachometer 104 has sufficient resolution to control the start of new tracks (e.g., post-pause tracks) to within a small portion of a track width. Using the capstan tachometer position (obtained at step 3-3) as a reference allows for a simple method for starling to write new tracks after the pause.

Knowledge of the drum rotation position is achieved through an unillustrated position sensor associated with most the scanners of most tape drives. Similarly, most tape drives provide a signal which indicates when a head is over a tape and in a position to begin to traverse and transducer (record or reproduce) a track. In some tape drives such as some of the helical scan examples previously referenced, such a signal is known as a HEAD SYNC signal. Other variations are also possible.

The signal to begin writing again following the pause will always take effect on the start of the next drum revolution. Each drum revolution writes two tracks, so in the example implementation on average there will be one track of additional separation between the pre-pause and post-pause data. In other embodiments in which the tape speed and drum timing are servo controlled, this distance can be reduced further.

In some embodiments or modes of operation there may be no synchronization between the capstan tachometer 104 and the head timing, particularly if tape speed and drum (scanner) speed are independently controlled. In embodiments in which the capstan 100 and head timing are not synchronized, there is another situation that must be avoided or countered. Specifically, if two events occur essentially simultaneously, a last pre-pause track may be accidentally recorded over. These two events are: (1) the capstan tachometer position (monitored at step 3-7) matching (as determined at step 3-8) the saved position (obtained at step 3-3); and (2) the head timing write gate goes active. These two events occurring essentially simultaneously this leads to writing a track immediately. There is a chance that starting this write operation this quickly could cause the last track of the pre-pause data to be overwritten in such a way that the pre-pause data track width will be reduced below an acceptable limit. Having the programmable offset mentioned above allows adjustment of this point to err on the side away from the pre-pause data and avoid over trimming the last pre-pause data track.

This pause routine 120 will most often will create a gap of previously recorded data. However, by using DC erasing at the end of the pause, the exposed portion would appear to be erased. This avoids the effects of like-azimuth data from what is previously recorded in the small gap and the newly recorded data.

The pause technology described herein can be performed by tape drives having a number of heads different than the example implementation described and illustrated. In fact, the pause technology can be used on a system with any number of heads, including a system having only one write head. In the case of one head, other issues may have to be taken into account, such as the recording with one azimuth and thereby having to allow a separation to avoid reading same azimuth tracks. The person skilled in the art recognizes the nature of adaptations for implementing the pause routine technology in such embodiments and the measures necessary for accomplishing such adaptations.

Although various embodiments have been shown and described in detail, the claims are not limited to any particular embodiment or example. None of the above description should be read as implying that any particular element, step, range, or function is essential such that it must be included in the claims scope. The scope of patented subject matter is defined only by the claims. The extent of legal protection is defined by the words recited in the allowed claims and their equivalents. It is to be understood that the invention is not to be limited to the disclosed embodiment, but on the contrary, is intended to cover various modifications and equivalent arrangements.

What is claimed is:

1. A helical scan tape recorder comprising:
a rotatable scanner;
a transport system for transporting magnetic tape proximate the rotatable scanner in a manner so that information is recorded during a revolution of the scanner;
a controller for performing a pause routine, the pause routine when executed comprising performing the steps of:
determining a tape pause position reference value indicative of a pre-pause last recording position on the tape;
recording a signal on the tape after the pre-pause last recording position which nullifies previously existing information recorded after the pre-pause last recording position;
rewinding the tape;
transporting the tape in a forward direction and obtaining a current tape position value;
determining when the current tape position value reaches a predetermined value relative to the tape pause position reference value; and
at beginning of a next revolution of the scanner, commencing recording of one or more post-pause stripes on the tape.

2. The apparatus of claim 1, wherein the predetermined value relative to the tape pause position reference value is a sum of the tape pause position reference value and an offset value.

3. The apparatus of claim 2, wherein the offset value is programmable.

4. The apparatus of claim 1, wherein the step of recording the signal on the tape after the pre-pause last recording position which nullifies the previously existing information recorded after the pre-pause last recording position is a DC erase signal.

5. A method of operating a helical scan tape recorder having a transport system for transporting magnetic tape proximate a rotatable scanner in a manner so that information is recorded during a revolution of the scanner, the method comprising:
determining a tape pause position reference value indicative of a pre-pause last recording position on the tape;
recording a signal on the tape after the pre-pause last recording position which nullifies previously existing information recorded after the pre-pause last recording position;
rewinding the tape;
transporting the tape in a forward direction and obtaining a current tape position value;
determining when the current tape position value reaches a predetermined value relative to the tape pause position reference value; and
at beginning of a next revolution of the scanner, commencing recording of one or more post-pause stripes on the tape.

6. The method of claim 5, wherein the predetermined value relative to the tape pause position reference value is a sum of the tape pause position reference value and an offset.

7. The method of claim 6, wherein the offset value is programmable.

8. The method of claim 5, wherein the step of recording the signal on the tape after the pre-pause last recording position which nullifies the previously existing information recorded after the pre-pause last recording position is a DC erase signal.

9. A method of operating a helical scan tape recorder having a transport system for transporting magnetic tape proximate a rotatable scanner in a manner so that information is recorded during a revolution of the scanner, the method comprising:
encountering a tape pause situation; and
recording a DC erase signal on the tape after the pre-pause last recording position before recording post-pause data on the tape.
